(19) United States
(12) Patent Application Publication
(10) Pub. No.: US 2008/0078123 A1
(43) Pub. Date: Apr. 3, 2008

(54) MEDICAL IMAGE DIAGNOSTIC APPARATUS

(75) Inventor: Wei WEI, Dalian (CN)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 11/863,685

(22) Filed: Sep. 28, 2007

(30) Foreign Application Priority Data
Sep. 29, 2006 (CN) 200610141550.0
Mar. 22, 2007 (CN) 200710088770.6

(51) Int. Cl. E05F 15/00

(52) U.S. Cl. 49/136

(57) ABSTRACT

A medical image diagnostic apparatus including a frame which accommodates a main portion of the medical diagnostic apparatus, and a cover which is configured to be opened/closed by a hinge with respect to the frame, includes a power assist mechanism attached inside the cover, and a link bar which links a movable point of the power assist mechanism to a stationary point of the frame.

### CROSS-REFERENCE TO RELATED APPLICATIONS

This application is based upon and claims the benefit of priority from prior Chinese Patent Applications No. 200610141550.0, filed Sep. 29, 2006; and No. 200710088770.6, filed Mar. 22, 2007, the entire contents of both of which are incorporated herein by reference.

### BACKGROUND OF THE INVENTION

1. Field of the Invention

The present invention relates to a comparatively large medical image diagnostic apparatus having an openable/closeable box body structure.

2. Description of the Related Art

Regarding a large box body structure such as a medical image diagnostic apparatus or automobile, when opening its back cover, the user must lift the cover, as shown in FIG. 1. If the cover is heavy (e.g., 20 kg or more) and the height of its pivot fulcrum is higher than the human height, it is difficult for the user to open the cover through 90° for himself. Two persons must stand on the two sides of the apparatus, open the cover together, and support the cover with pillars.

Particularly, in a large apparatus such as an X-ray CT diagnostic apparatus, to maintain the interior of the apparatus, the user must open the front cover of the apparatus. At this time, as the cover is heavy and large, it is difficult for the user to open it for himself. This decreases the operation efficiency and increases the personnel cost, leading to poor services.

To solve this problem, Jpn. Pat. Appln. KOKAI Publication No. 11-152954 proposed a booster mechanism with which the cover can be opened conveniently.

According to this apparatus, as shown in, e.g., FIG. 2, a frame 1a serving as an apparatus main body is provided with a spring means 4, and a cover 1e is provided with a pillar 7 connected to the spring means 4. When opening the cover 1e, the spring means 4 allows the user to open the cover 1e with a force smaller than in the conventional case.

In this apparatus, the spring means, particularly a booster mechanism such as a gas spring, is set on the frame of the apparatus main body. This requires a predetermined space, and the layout of the space of the apparatus main body is limited. Such a booster mechanism is not optimal in saving the force.

### BRIEF SUMMARY OF THE INVENTION

It is an object of the present invention to reduce the load of the task of opening a cover which is opened and closed with respect to a frame that contains the main portion of a medical image diagnostic apparatus and to suppress a decrease in accommodation space of the frame.

According to an aspect of the present invention, there is provided a medical image diagnostic apparatus comprising a frame which accommodates a main portion of the medical diagnostic apparatus, and a cover which is configured to be opened/closed by a hinge with respect to the frame, characterized by comprising: a power assist mechanism attached inside the cover; and a link bar which links a movable point of the power assist mechanism to a stationary point of the frame.

The present invention can reduce the load of the task of opening the cover which is opened and closed with respect to the frame that contains the main portion of the medical image diagnostic apparatus and suppress a decrease in accommodation space of the frame.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view explaining opening the cover of a conventional medical image diagnostic apparatus;

FIG. 2 shows an example of a booster mechanism for a conventional box body structure;

FIG. 3 is a side sectional view showing a medical image diagnostic apparatus according to an embodiment of the present invention;

FIG. 4 is a view showing a method of setting a stretching mechanism for the medical diagnostic apparatus according to the embodiment of the present invention;

FIG. 5 is a view showing another method of setting the stretching mechanism for the medical image diagnostic apparatus according to the embodiment of the present invention;

FIG. 6 is a view sowing still another method of setting the stretching mechanism for the medical image diagnostic apparatus according to the embodiment of the present invention;

FIG. 7 is a view showing still another method of setting the stretching mechanism for the medical image diagnostic apparatus according to the embodiment of the present invention;

FIG. 8 is an applied force analytical diagram of the medical image diagnostic apparatus according to the embodiment of the present invention;

FIG. 9 is an applied force analytical diagram of the medical image diagnostic apparatus according to the embodiment of the present invention;

FIG. 10 is an applied force analytical diagram of the medical image diagnostic apparatus according to the embodiment of the present invention;

FIGS. 11A to 11C are applied force analytical diagrams, respectively, of the medical image diagnostic apparatus according to the embodiment of the present invention;

FIG. 12 is a graph showing the relationship between the opening force and opening angle of the medical image diagnostic apparatus according to the embodiment of the present invention; and

FIG. 13 is a stereoscopic view of the medical image diagnostic apparatus according to the embodiment of the present invention.

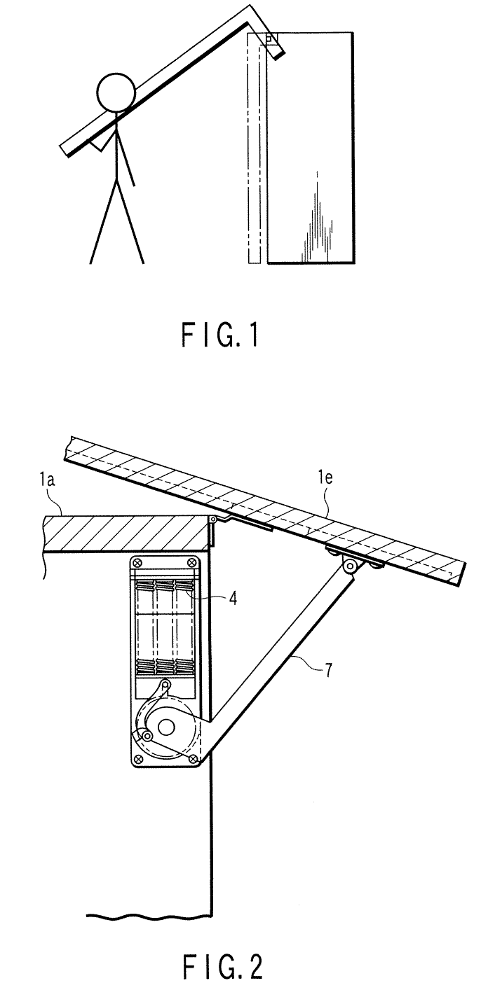

### DETAILED DESCRIPTION OF THE INVENTION

The embodiment of the present invention will be described with reference to the accompanying drawings.

The box body of a medical image diagnostic apparatus according to this embodiment is often called a gantry which accommodates the main portion of the medical image diagnostic apparatus. For example, when the medical image diagnostic apparatus is an X-ray computerized tomographic apparatus, the gantry accommodates a rotary ring, an X-ray tube to mount on the rotary ring, and an X-ray detector to mount on the rotary ring. The gantry may also accommodate a high voltage generator which generates a high voltage to apply to the X-ray tube, and furthermore a data acquisition system called DAS.

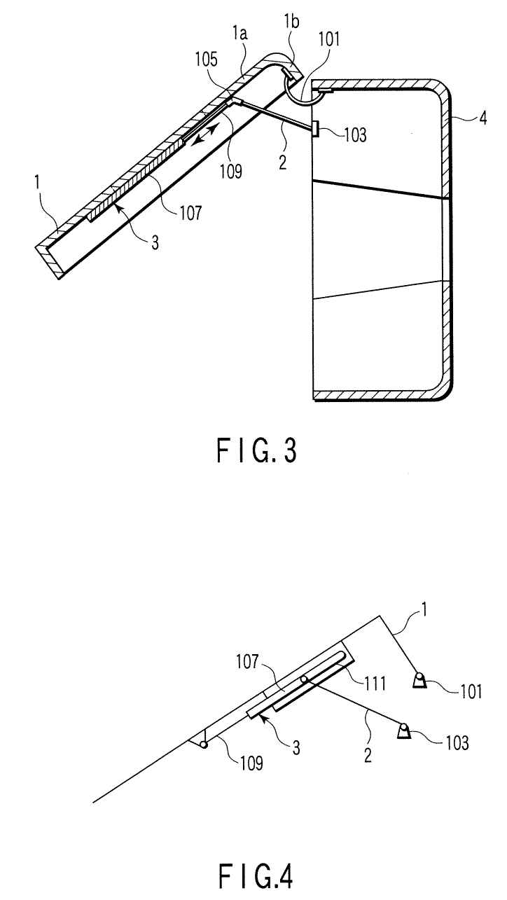

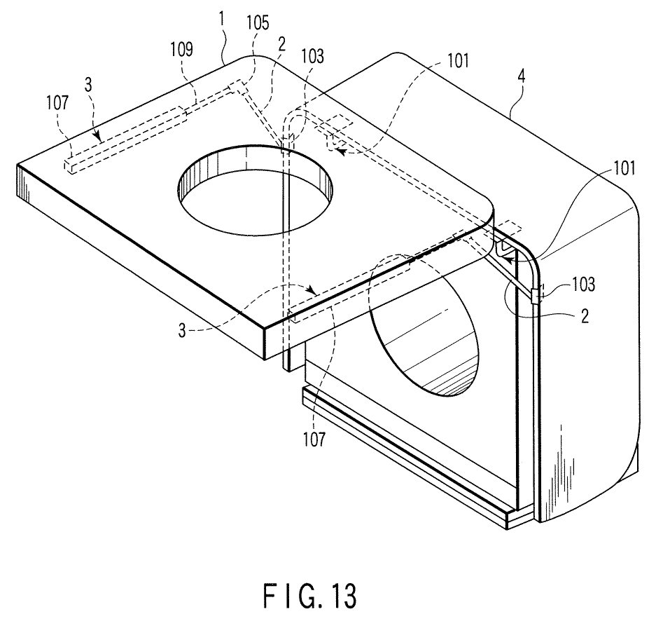

As shown in FIGS. 3 and 13, the apparatus comprises a box-like frame 4 and a cover 1 which is openable/closeable with respect to the frame 4. A C- or U-shape hinge 101 connects the cover 1 at the top portion to the frame 4 to be openable/closeable. The hinge 101 is provided inside the cover 1 and frame 4. When closing the cover 1, the hinge 101 is accommodated inside the cover 1 and frame 4. The inner side of the cover 1 is provided with a pair of power assists 3. The power assists 3 assist the operator with a force necessary to lift and open the cover 1. One power assist 3 is arranged on the left end of the cover 1 and the other power assist 3 is arranged on the right end of the cover 1, so the power assists 3 will not interfere with the contents of the frame 4.

Each power assist 3 is a stretching mechanism which typically uses a gas spring. The power assist 3 (to be referred to the stretching mechanism or spring hereinafter when appropriate) has a cylinder 107 to fix to the inner side of the cover 1 and a shaft 109 movable with respect to the cylinder 107. Gas sealed in the cylinder 107 biases the shaft 109 in a direction to stretch toward the cylinder 107. One end of a link bar (to be referred to as a pillar hereinafter) 2 is connected to the movable end of the shaft 109 through a free joint 105. The other end of the pillar 2 is connected to a predetermined position (fixing portion) of the frame 4 through a free joint 103.

Alternatively, as shown in FIG. 4, one end of the stretching mechanism 3 may fix to the frame 4, and the cylinder 107 may be movably provided to a groove structure 111. One end of the cylinder 107 is connected to one end of the pillar 2 through the free joint 105.

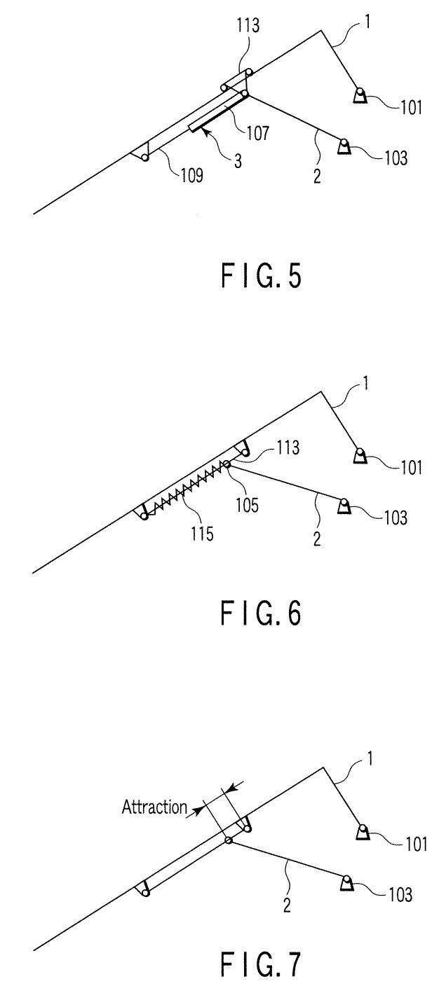

Alternatively, as shown in FIG. 5, one end of the cylinder 107 may movably attach to a guide rail 113 provided along the cover 1 and having pulleys.

Alternatively, as shown in FIG. 6, the stretching mechanism 3 has a spring shaft 113 supported by the inner surface of the cover 1, and a coil spring 115 inserted in the spring shaft 113. One end of the coil spring 115 is connected to one end of the pillar 2 through the free joint 105.

Alternatively, as shown in FIG. 7, the stretching mechanism 3 may include a link bar which is slidably connected to the other end of the pillar, and an excitation coil which, upon energization, generates an attraction force or a repulsion force with respect to the link bar to slide the link bar.

In this embodiment, as shown in FIG. 3, the cover 1 has a front portion 1a and an edge portion 1b. The cover 1 may comprise only the front portion 1a. This embodiment will be exemplified hereinafter by a structure in which the cover 1 has a front portion 1a and an edge portion 1b.

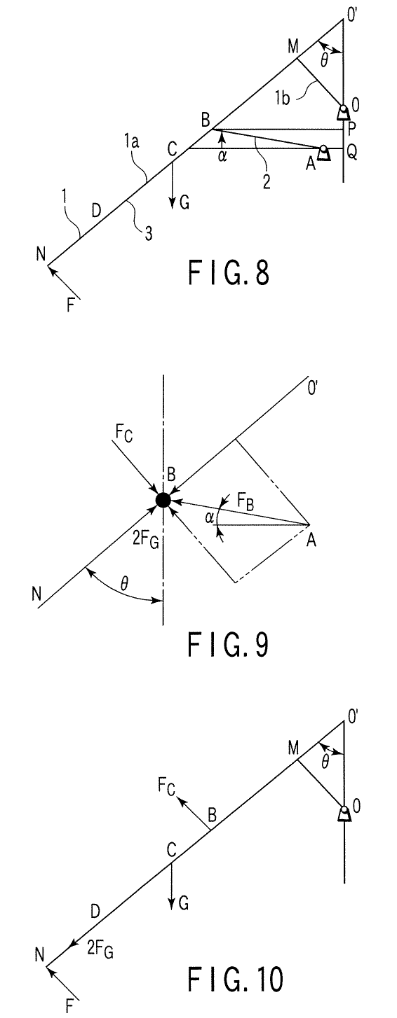

The applied force analysis of the cover 1 will be explained. Referring to FIG. 8,

D: the spring fixing end (the fixing end of the cylinder 107 of the stretching mechanism 3)

A: the connection end of the link bar 2 to the frame 4

B: the spring stretching end (the movable end of the shaft 109 of the stretching mechanism 3)

C: the barycenter of the cover 1

G: the gravity of the cover 1

F: the force of action applied to the cover 1 by the operator

θ: the angle at which the cover 1 is open

α: the angle formed by the pillar 2 and the horizontal direction; from the horizontal line to the pillar 2, the left-handed angle is positive

Referring to FIG. 8, O′ is a virtual point necessary to explain the angle θ at which the cover 1 is open.

As the cover 1 opens, the stretching mechanism 3 stretches and pushes the pillar 2 forward to rotate the cover 1 clockwise on the sheet of drawing. The angle θ at which the cover 1 is open becomes close to 90° due to the operation of the pillar 2. When selecting an appropriate gas spring and then opening the cover at 90°, the gravity of the cover 1 and the elastic force of the stretching mechanism 3 become close to balanced moments.

The geometric relationship, i.e., the relationship between α and θ, of this embodiment will be analyzed hereinafter.

Since a triangle MOO′ and a triangle PBO′ are approximate,

$$Δ {MOO}^{′} ∞Δ {PBO}^{′} \frac{OM}{BP} = \frac{{O}^{′} M}{{O}^{′} P} \\ {O}^{′} M = OM \times ctg θ \\ BP = BQ + QP = AB \times cos α + QP \\ {O}^{′} P = {OO}^{′} + OR - AQ = \frac{OM}{sin θ} + OR + AB \times sin α \\ \frac{OM}{AB \times cos α + QP} = \frac{OM \times ctg θ}{\frac{OM}{sin θ} + OR + AB \times sin α} \\ α = arccos ( \frac{OM + OR sin θ - QP cos θ}{AB} ) - θ \qquad ( 1 )$$

The spring force (the stretching force of the stretching mechanism 3) will be analyzed.

Assume that the length of the stretching mechanism 3 is BD.

When θ=0°,

$$\begin{matrix}BD = MD - OR - AB \times cos α \\ MB = MD - BD \\ When θ \neq 0 ° , & ( 2 ) \\ MB = \frac{AB \times cos α + QP - OM \times cos θ}{sin θ} \\ BD = MD - MB & ( 3 )\end{matrix}$$

Assuming that the length of the stretching mechanism 3 is L0, the characteristic coefficient of the stretching mechanism 3 is K, the spring force is F_{G}, and the definition reactive force of the stretching mechanism 3 is F,

F_{G}=K(BD−L₀)+F₀ (4)

Analysis on applied forces:

The state of applied forces at the point B, FIG. 9

F_{G}: the compression force at the point B by the stretching mechanism 3

F_{B}: the force of action at the point B by the pillar 2

F_{C}: the constraint force at the point B by the cover 1

Assuming that applied forces at the point B balance, equations indicating the balance of the forces at the point B are expressed as:

$$\{ \begin{matrix}{F}_{B} sin ( θ + α ) = 2 {F}_{G} ⇒ {F}_{B} = \frac{2 {F}_{G}}{sin ( θ + α )} \\ {F}_{B} cos ( θ + α ) = {F}_{C} ⇒ {F}_{C} = \frac{2 {F}_{G} cos ( θ + α )}{sin ( θ + α )}\end{matrix} \qquad ( 5 )$$

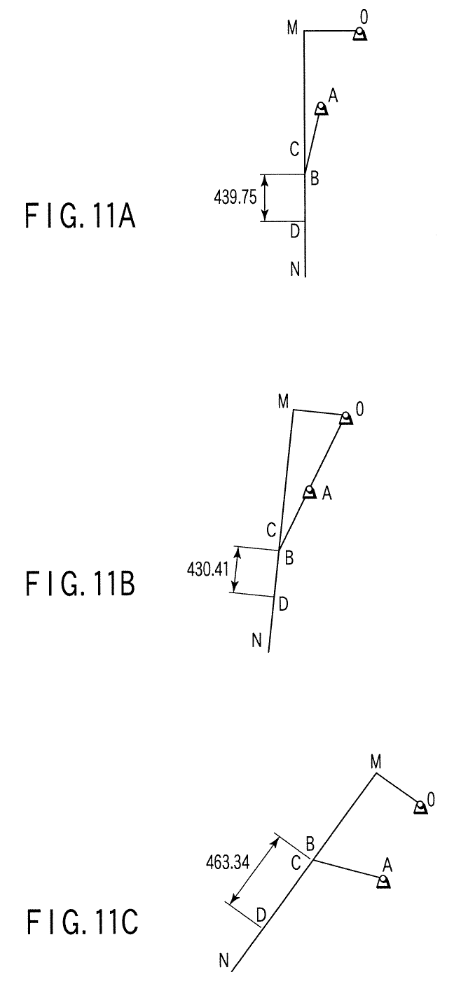

FIG. 10 shows the state of applied forces of the cover 1. An equation indicating the balance of moments at a point O is expressed as:

$$\begin{matrix}F = \frac{{F}_{C} \times MB - G ( OM cos θ + MC sin θ ) - 2 {F}_{G} \times OM}{MN} & ( 6 ) \\ \sum {M}_{O} = M ( F ) + M ( {F}_{C} ) - M ( G ) - M ( 2 {F}_{G} ) = 0 \\ F \times MN + {F}_{C} \times MB - G ( OM cos θ + MC sin θ ) - 2 {F}_{G} \times OM = 0 & ( 7 )\end{matrix}$$

Analysis on kinetic characteristics

(see FIGS. 11A, 11B, and 11C):

The compression amount of the spring is the largest (a line B-D is the shortest) when OAB is collinear. Assume that the angle at which the cover is open at this time is θm. If the position of a point A is selected on the upper left side of a straight line OB when θ=0°, that is, on a side to be close to the direction of opening the cover (FIG. 11A), an external force compresses the spring before opening the cover at the angle θm, and the spring does stretch after the angle exceeds θm. If the position of the point A is selected on the straight line OB when θ=0°, or the lower left side of the straight line OB, the spring stretches while opening the cover. A process during which an external force compresses the spring does not exist.

Seen from the viewpoint of the user, the spring desirably provides as large as possible an elastic force (the compression amount of the spring is as large as possible) when opening the cover at 90°. This is because it is when the cover is to be opened high to be parallel to the floor surface, the moment of the gravity to overcome is the largest, and it is difficult for the user to apply a force. When the cover is closed or open with a small angle, the moment of gravity to overcome is small, and the user can overcome the elastic force of the spring with a partial force of action. The user must be able to apply a force easily and the cover must be closed completely when he closes it. Hence, at this time, desirably the spring does not have a large elastic force, or the elastic force of the spring is as small as possible (it is preferable if no force is applied).

Solution:

On the basis of the above analysis, the technical idea, that the position of the point A is on the upper left side of the straight line OB when θ=0°, that is, on that side of the straight line OB to be close to the direction of opening the cover, is preferable. This is because it allows the force of action of the user to compress the spring to a small angular position.

Practical examples of the size of the spring will be described hereinafter.

TABLE 1

| Known condition | | | Selected parameter | | | | | Spring | | | |
|---|---|---|---|---|---|---|---|---|---|---|---|
| MN (mm) | MC (mm) | G (Kgf) | OM (mm) | QP (mm) | OR (mm) | AB (mm) | MD (mm) | K (Kgf/mm) | L (mm) | F₀ (mm) | L₀ (mm) |
| 1530 | 800 | 35 | 128.25 | 105.4 | 206.55 | 586 | 1200.5 | 0.066829268 | 627 | 39.7 | 412 |

| | | Calculation parameter | | | | | Test |
|---|---|---|---|---|---|---|---|
| 0° | F (Kgf) | α° | BD (mm) | F_{C} (Kgf) | MB (mm) | F_{G} (Kgf) | ΔL (mm) |
| 0.00 | 8.16 | 88.06 | 408.29 | 2.67 | 792.21 | 39.45 | 218.71 |
| 1.00 | 8.21 | 86.70 | 406.56 | 3.15 | 793.94 | 39.34 | 220.44 |
| 10.00 | 8.54 | 74.38 | 395.08 | 7.59 | 805.42 | 38.57 | 231.92 |
| 20.00 | 8.64 | 60.47 | 391.42 | 12.87 | 809.08 | 38.32 | 235.58 |
| 30.00 | 8.36 | 46.41 | 397.82 | 18.73 | 802.68 | 38.75 | 229.18 |
| 40.00 | 7.64 | 32.32 | 414.28 | 25.41 | 786.22 | 39.85 | 212.72 |
| 50.00 | 6.42 | 18.29 | 440.27 | 33.2 | 760.23 | 41.59 | 186.73 |
| 60.00 | 4.75 | 4.43 | 474.74 | 42.00 | 725.76 | 43.89 | 152.26 |
| 70.00 | 2.76 | −9.13 | 516.12 | 52.00 | 684.38 | 46.66 | 110.88 |
| 80.00 | 0.67 | −22.27 | 562.3 | 62.82 | 638.13 | 49.75 | 64.63 |
| 90.00 | −1.24 | −34.84 | 611.16 | 73.80 | 589.34 | 53.01 | 15.84 |
| 91.00 | −1.41 | −36.07 | 616.08 | 74.88 | 584.42 | 53.34 | 10.92 |
| 92.00 | −1.58 | −37.28 | 621.00 | 75.94 | 579.50 | 53.67 | 6.00 |
| 93.00 | −1.74 | −38.49 | 625.91 | 76.99 | 574.59 | 54.00 | 1.09 |
| 93.22 | −1.78 | −38.75 | 627.00 | 77.23 | 573.50 | 54.07 | 0.00 |

In Table 1, ΔL is the compression amount of the spring.

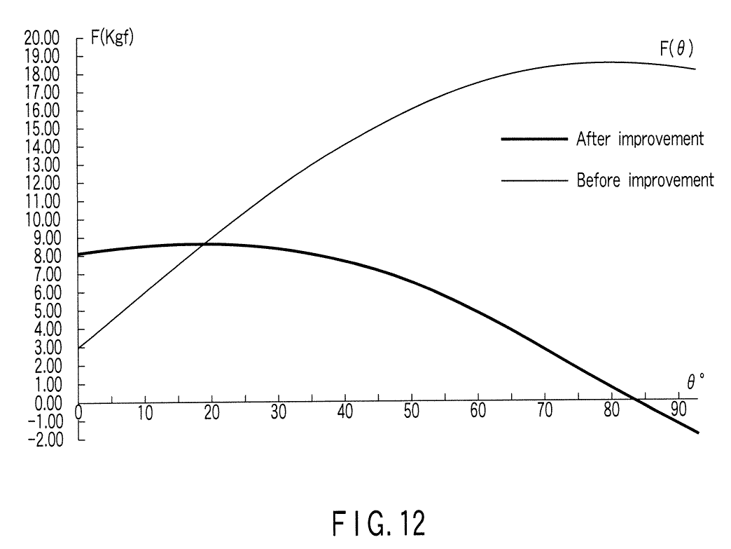

On the basis of the above results, curves along which the user applies forces are obtained as shown in FIG. 12. For the sake of comparative explanation, FIG. 12 shows a curve obtained by using the booster mechanism of this embodiment and a curve obtained without using the booster mechanism of this embodiment.

From FIG. 12, the structure provided by this embodiment allows the user to open the cover quickly with a small force. By utilizing this structure, the user can open the cover easily for himself, and the consumed force for opening is 10 kgf or less.

In FIG. 12, the cover 1 can reliably obtain a stable state both when θ=0° and θ=90°. To change the state of 0° requires 8 kgf, and to change the state of 90° requires 2 kgf. When θ=0°, the force that the user applies is negative. This indicates that an upward force is not necessary. As the spring force is reversed downward, the balance can be maintained only by applying a downward force. As a result, when the cover 1 is open to the limit, the user need not be afraid that the cover 1 may descend. From the calculation result, the spring reaches the maximal stroke when θ=93.22°. Thus, moment imbalance does not continuously increase the opening angle (the cover stops at 93.22°). As a result, this structure can guarantee the stability of both the open state and closed state (bistability) of the cover.

The opening force becomes maximal when the cover 1 is at a small angle. Regarding the operation of opening the cover 1, it needs a change. More specifically, when changing the operation so as to lift the cover 1 from a predetermined angle after the cover 1 is pulled and opened, it is difficult to apply a force. With this mechanism, the opening force decreases when it is difficult to apply. This facilitates the process of opening the cover 1.

When closing the cover 1, the force to close the cover 1 is constituted by combining the force of the user with the weight of the cover 1 itself. Thus, a large force does not act on the cover 1.

As a method of fixing the cover 1 after it opens, for example, the following method can be employed.

The pillar 2 is rotatably fixed to the side wall of the frame 4. The side portion of the cover 1 comprises an inserting portion for inserting the pillar 2. After opening the cover 1, the pillar 2 is inserted in the inserting portion of the cover 1. When closing the cover 1, the pillar 2 is pulled out from the inserting portion, and the cover 1 is closed. The present invention is not limited to this structure, but can employ another fixing mechanism, i.e., a mechanism that stops contraction of the contracting portion of the stretching mechanism when the cover 1 is open at a certain angle.

The tables attaching to this embodiment can be employed as calculation tools. For an apparatus having a different size and a different requirement, the curve of a new opening force can be obtained only by correcting the known conditions and selected parameters of the tables.

When adopting the opening/closing structure of this embodiment in an X-ray CT apparatus, it is preferable to set the stretching device (gas spring) 3 along the inner side of the cover 1 on the side portion of the cover 1, i.e., to set it along the inner side of the cover 1 on a side which is inclined with respect to the frame 4 during the process of opening the cover 1.

The stretching device (gas spring) 3 is set in the above manner due to the following reason. The inner side of the cover 1 on the side portion of the cover 1 is a space that is not used usually. When setting the stretching mechanism of this embodiment at this position, the space can be used efficiently. When the apparatus comprises an opening/closing mechanism which allows the user to open the cover for himself with a small force without increasing the size of the apparatus itself, the operation efficiency increases.

As the opening/closing mechanism of this embodiment can be set without requiring a large space, it helps in downsizing the apparatus. As the stretching mechanism 3 is set on the side portion of the cover 1, it can guarantee the strength of the layout space of the stretching mechanism 3 and increase the strength of the cover 1.

This is because although the cover 1 is made of a resin to minimize its weight, since the cover 1 is large, it needs bending. For example, the two lower corners of the cover 1 are bent in an L shape inwardly of the cover 1. This prevents the cover 1 from being bent when opening/closing it. According to this embodiment, the stretching mechanism is set on the side portion of the cover, so it can improve the strength of the cover 1 and prevent or decrease bent.

Although this embodiment is exemplified so far by a medical image diagnostic apparatus, it is not limited to this. For example, other than a structure that opens the back cover of a truck or microbus, this embodiment can also be used in another similar box body structure. A person skilled in the art can modify the present invention in various manners.

The present invention is not limited to the above embodiment as it is. When practicing the present invention, it can be embodied by modifying the constituent elements without departing from the spirit and scope of the invention. Appropriate combinations of the constituent elements disclosed in the above embodiment can constitute various inventions. For example, several ones may be omitted from the entire constituent elements shown in the embodiment. Also, constituent elements of different embodiments may be combined appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical image diagnostic apparatus comprising a frame which accommodates a main portion of the medical diagnostic apparatus, and a cover which is configured to be opened/closed by a hinge with respect to the frame, comprising:
a power assist mechanism attached inside the cover; and
a link bar which links a movable point of the power assist mechanism to a stationary point of the frame.

2. An apparatus according to claim 1, wherein the power assist mechanism comprises a stretching mechanism, and a stretching direction of the power assist mechanism is substantially parallel to the cover.

3. An apparatus according to claim 1, wherein the power assist mechanism comprises a stretching mechanism, the stretching mechanism comprising a spring mechanism with one end fixing to the cover and the other end connected as a movable end to the other end of a pillar.

4. An apparatus according to claim 3, wherein the movable end of the spring mechanism is movably attached to a groove structure which is set along the cover.

5. An apparatus according to claim 3, wherein the movable end of the spring mechanism is movably attached to a guide rail which is set along the cover.

6. An apparatus according to claim 3, wherein the spring mechanism comprises a gas spring mechanism.

7. An apparatus according to claim 1, wherein the power assist mechanism includes a spring bar with two ends fixed to the cover, and a coil spring inserted in the spring bar, one end of the coil spring being fixed and the other end thereof being connected to the other end of the link bar.

8. An apparatus according to claim 1, wherein the power assist mechanism includes a bar slidably connected to the other end of the link bar and an excitation coil which moves the bar.

9. An apparatus according to claim 1, wherein the cover comprises a front portion and an edge portion, the edge portion being connected to the hinge.

10. An apparatus according to claim 9, wherein when the cover is kept closed, a connection point of the link bar and the frame is located on a cover side of a line that connects a connection point of the hinge and the frame and a connection point of the link bar and the power assist mechanism.

11. An apparatus according to claim 10, wherein the power assist mechanism includes a stretching force which balances with a weight of the cover when the front portion is substantially parallel to a floor surface.

12. An apparatus according to claim 10, wherein the power assist mechanism exhibits a largest stretching force when the cover is kept closed and a smallest stretching force when the front cover is parallel to a floor surface.

13. An apparatus according to claim 1, wherein the medical image diagnostic apparatus comprises an X-ray CT apparatus.

14. A box body mechanism comprising a frame and a cover which is configured to be opened/closed by a hinge with respect to the frame, comprising:
a power assist mechanism attached inside the cover; and
a link bar which links a movable point of the power assist mechanism to a stationary point of the frame.
